(19) United States
(12) Patent Application Publication
(10) Pub. No.: US 2004/0055590 A1
(43) Pub. Date: Mar. 25, 2004

(54) Barbeque apparatus

(76) Inventors: Kent E. Warnick, Pleasant Grove, UT (US); Carey A. Christenson, American Fork, UT (US)

Correspondence Address: Robert R. Meads, 533 Via Almar, Palos Verdes Estates, CA, 90274, US

(21) Appl. No.: 10/253,624

(22) Filed: Sep. 24, 2002

(51) Int. Cl. A47J 37/00

(52) U.S. Cl. 126/25 R; 126/25 AA; 126/9 R

(57) ABSTRACT

A barbeque apparatus comprising a heat source container having an open top, a grill and a support structure supporting the grill to extend over the open top and for horizontal movement away from and toward the container to control the amount of heat from a heat source in the container reaching different portions of the grill.

### FIELD OF INVENTION

The present invention relates to improvements in apparatus for barbequing food items, preferably outside barbecues, and, more specifically to a barbeque including a grill structure which is manually moveable toward and away from a heat source which may be housed in a container included in the barbeque.

### BACKGROUND

Barbeques for cooking food items come in many shapes and sizes. Commonly, outside barbeques include a container or base structure for supporting or containing a heat source such as wood, charcoal or a gas or electric burner. Located above the container is a horizontal grill structure for supporting food items to be cooked by heat from the heat source.

Custom cooking of food items on such barbeques to the taste of different persons is always a challenge. For, example, some like their meat “rare”, others “medium” and still others “well done”. Since the grill structures associated with such barbeques are not readily moveable, the cook for such food items has limited options when it comes to such custom cooking. The cook can physically move the food items on the grill closer and further away from the heat source. However, such movement options are limited due to the proximity of the heat source to the food items. Also, it is very difficult to simultaneously cook food items to the different (e.g. “rare” to “well done”) preferences of others.

Usually this results in the cook controlling the cooking times in an attempt to differentiate between “rare” to “well done” food items. Unfortunately, such cooking time control does not allow for near simultaneous serving of food items, requires the constant attention of the cook and at best is a catch-as-catch-can proposition.

Accordingly, there is a need for a barbeque which is capable of simultaneously cooking different food items to different preferences (“rare” to “well done”). The barbeque of the present invention satisfies such needs by providing a grill structure that is easily moveable relative to the heat source contained in the barbeque.

### SUMMARY OF THE INVENTION

In a basic form, the barbeque of the present invention comprises a heat source container having an open top and a grill structure supported to extend horizontally over the open top of the container. The support for the grill includes structure that allows the grill to be easily moved by a cook away from and toward the container to control the amount of heat that different portions of the grill and food items located thereon are exposed. Such movement of the grill may be in horizontal and well as vertical planes as desired by the cook to control the degree to which different food items are simultaneous cooked.

### BRIEF DESCRIPTION OF DRAWINGS

FIG. 1 is a perspective view of a barbeque according to the present invention with a grill structure pivoted over a top of a heat source container.

FIG. 2 is a perspective view of the barbeque of FIG. 1 with the grill structure pivoted away from the heat source container.

FIG. 3 is a side view of the heat source container included in the barbeque of FIG. 1 having a heat shield around the container.

FIG. 4 is a top view of the grill structure for the barbeque of FIG. 1.

FIG. 5 is side view of the grill structure of FIG. 4.

FIG. 6 is a partial side view of a pivot structure for the grill structure of the barbeque of FIG. 1.

FIG. 7 is a partial side sectional view of a releasable locking mechanism for the grill structure of the barbeque of FIG. 1.

FIG. 8 is a partial side view of an alternate grill locking mechanism for the barbeque of FIG. 1.

FIG. 9 is a top view of the heat source container and heat shield of FIG. 1 illustrating radial supports extending inward from the container for supporting either or both a charcoal or wood supporting grid in the container adjacent a top or bottom thereof.

### DETAILED DESCRIPTION OF INVENTION

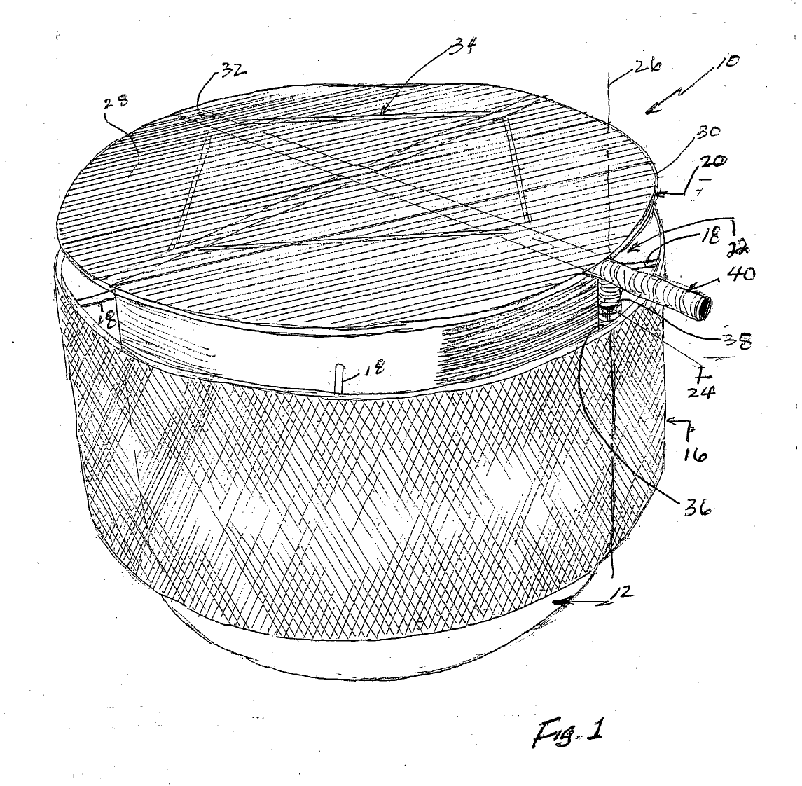

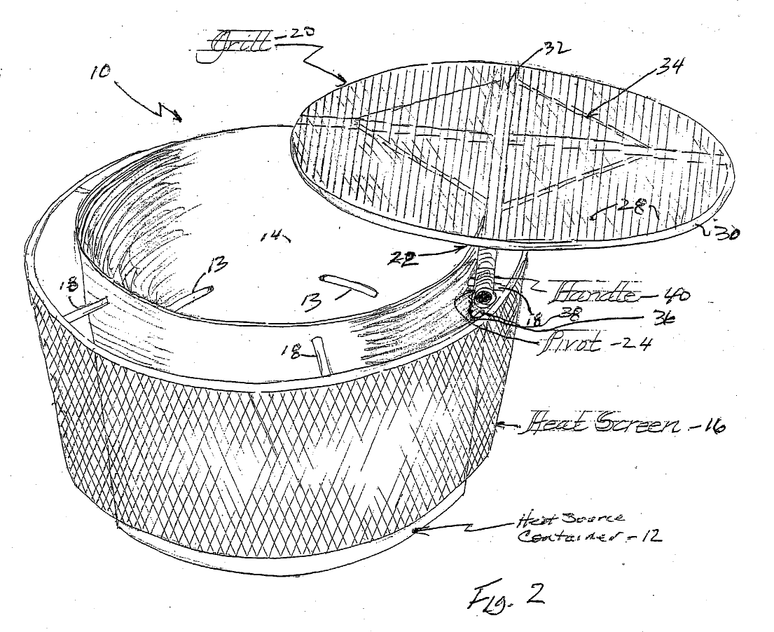

Referring to FIGS. 1 and 2, a basic form of the present invention is illustrated comprising a barbeque apparatus 10. The apparatus comprises a heat source container 12 having an open top 14. Preferably, the container 12 comprises a vertically extending open metal cylinder having a plurality of lower side air vents 13 surrounded by a screen-like vertically extending tubular heat screen or shield 16 which is supported by radial arms 18 extending outwardly from the metal cylinder.

In addition to the heat source container 12 and heat shield 16, the barbeque 10 shown in FIGS. 1 and 2 comprises a grill structure 20 supported by a support structure 22. Generally speaking, the support structure 22 supports the grill structure 20 so as to extend over the open top 14 of the container 12 and for horizontal as well as vertical movement away from and toward the container between user selectable and releasably lockable positions to control the amount of heat from a heat source (not shown) in the container reaching different portions of the grill. A variety of heat sources may be housed within the container 12 including without limitation wood, charcoal and electric and gas heat sources.

In the barbeque 10 shown in FIGS. 1 and 2, the support structure 22 includes a pivot structure 24 for swinging the grill structure 24 away from and towards the container 12 about a vertical axis 26.

Where as shown, the container 12 comprises a vertically extending metal cylinder and the illustrated grill structure 20 comprises a grid 28 extending horizontally within a circular metal rim 30 and supported by a horizontal diametric support rod 32 and rectangular framework 34, the pivot structure 24 comprises (1) a vertically extending sleeve 36 secured to an inner surface of the heat shield 16 and relative to the container 12 and (2) a vertically extending rod 38 secured to extending downwardly from the horizontal grill support rod 32 into the sleeve 36 to support the grill structure for horizontal swinging movement over the open top 14 of the cylinder 12. In particular, such horizontal swinging movement is effected by a user grasping a heat insulated handle 40 extending outward from the horizontal support rod 32 and secured to the vertical rod 38 for turning the rod 38 in the sleeve 36 to swing the grill 20 over the open top 14 of the cylinder 12.

Preferably, the pivot structure 24 includes releasable locking means 42 for securing the grill over the open top 14 of the cylinder 12. Such locking means may take a variety of forms and may be utilized in combination or separate from means 44 for adjusting the vertical height of the grill structure 20 above the heat source container 12.

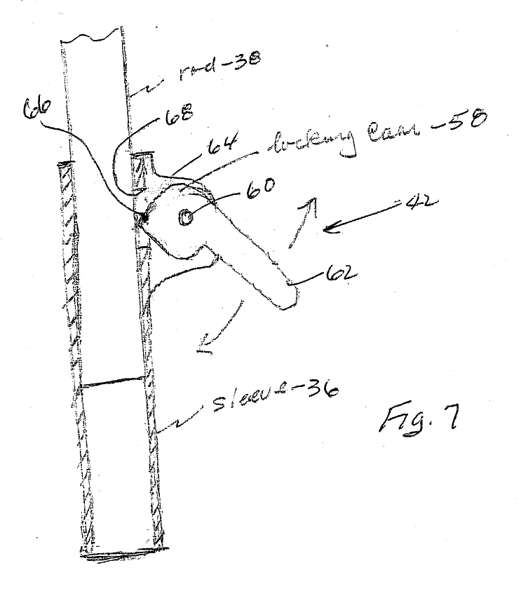

In the embodiment of the releasable locking means 42 shown in FIG. 6, the releasable locking means includes a cam surface 46 on the sleeve 36 and a cam follower 48 on the rod 38 for riding on the cam surface. Specifically in FIG. 6, the cam follower 48 comprises a removable metal pin 50 extending horizontally from the rod 38 to ride on the cam surface 46 on a top of the sleeve 36. In the illustrated version, the cam surface 46 comprises a horizontal top of the sleeve having diametrically opposing slots 52 into which the pin 50 will ride upon a turning of the handle 40 to position the grill 20 directly over the open top 14 of the cylinder 12 thereby releasably locking the grill in place. When it is desired to release the means 42 and swing the grill 20 to a different location relative to the cylinder 12, the user lifts up on the handle 40 and grill 20 to release the pin from the slots 52 and swings the grill about the axis 26.

Further, in the embodiment of FIG. 6, the rod 38 includes a plurality of vertically spaced horizontally extending holes 54 and 56 for selectively receiving the pin 50 to provide vertical adjustment of the height of the grill 20 above the open top 14 of the cylinder 12. In these regards, the metal pin 50 may be a conventional spring wire retained removable metal pin which is easily removable from one of the holes 54, 56 for selective and releasable placement in the other to adjust the height of the grill over the open top 14 of the cylinder 12.

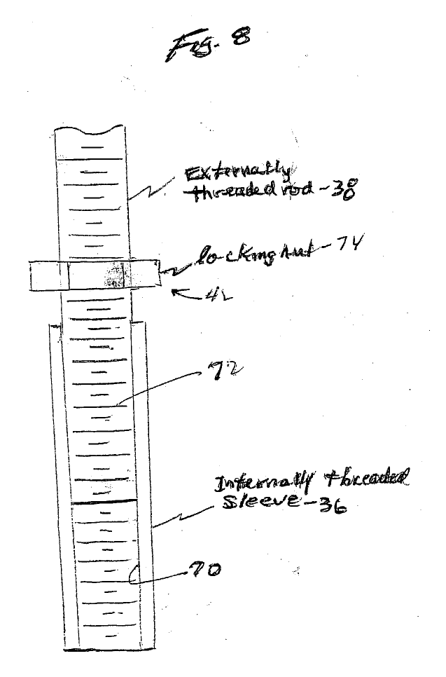

Alternatively, as shown in FIG. 7, the releasable locking means 42 may comprise a locking cam member 58. As shown, the cam member 58 is carried by and turnable on a pivot 60 secured to the sleeve 36 so as to selectively engage and lock against an outer surface of the rod 38. In this manner, the cam member 58 will releasably secure the rod 38 within the sleeve 36 and the grill structure 20 relative to the container 12. Specifically, as shown, the cam member 58 extends from a handle 62 and is supported for turning in a vertical plane on the pivot 60 which extends between two support arms 64 (only one of which is shown). Thus supported, a nose portion 66 of the cam member 58 extends through a side opening 68 in the sleeve 36 to engage and releasably lock against the rod 38 with a downward movement of the handle 62. By selective operation of the cam member 58 both the vertical height and rotational position of the grill 20 over the cylinder 12 may be controlled.

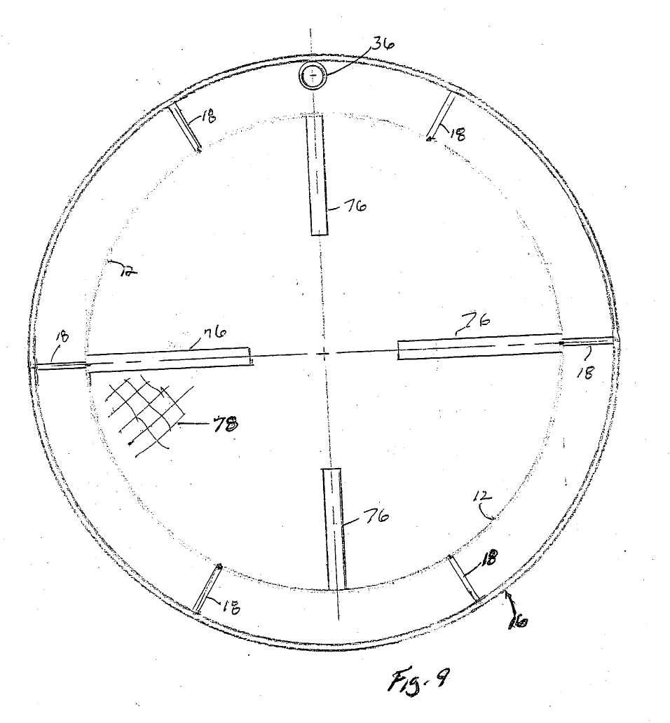

Still further, as shown in FIG. 8, the sleeve 36 may include an internally threaded portion 70 engaging an externally threaded portion 72 of the rod 38 whereby a turning of the rod relative to the sleeve moves the grill structure vertically relative to the heat source container. Further, in the embodiment of FIG. 8, the releasable means 42 includes a locking nut 74 on the rod for engaging and locking the rod relative to the sleeve to selectively secure the grill in place over or away from the container 12.

While particular embodiments of the present invention have been illustrated and described hereinabove, it should be appreciated that changes and modifications may be made in the described embodiments without departing from the spirit of the present invention.

For example, as previously stated, a variety of different heat sources may be housed within the container 12, e.g wood or charcoal. FIG. 9 depicts a number of radially extending horizontal support rods or arms 76 secured to and extending inward from an inner surface of the metal cylinder 12 and supporting a grid structure 78 (partially shown). The vertical location of the arms 76 may be preselected depending upon whether they are to only support the grid 78 adjacent the open top 14 of the cylinder 12 to provide support for charcoal or only adjacent a lower end of the cylinder so that the grid will support wood, or both.

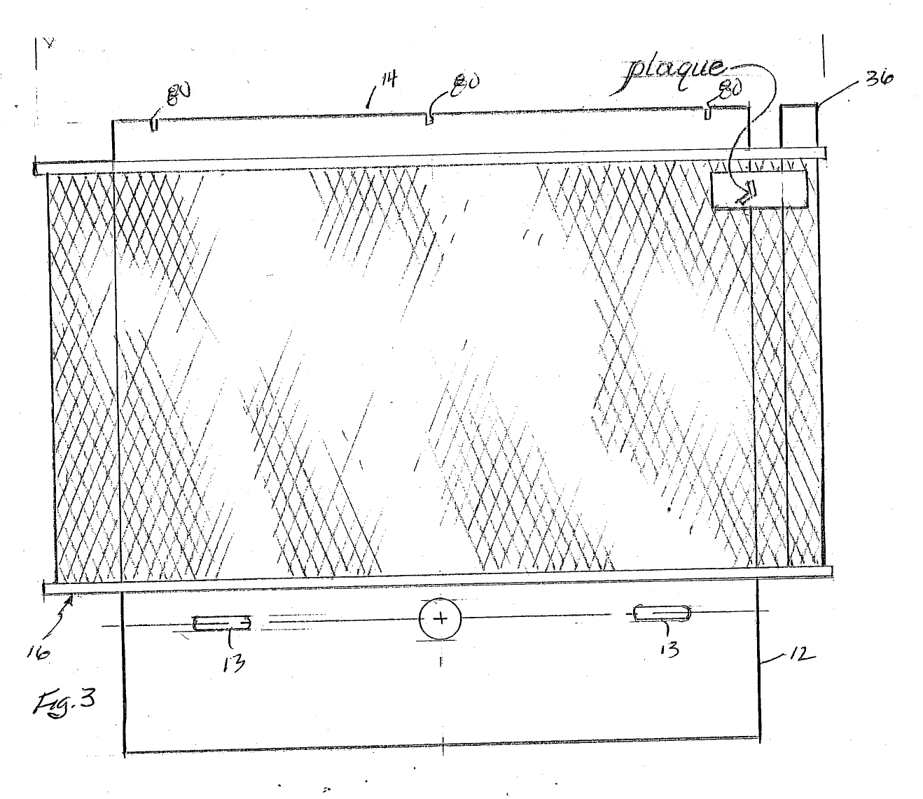

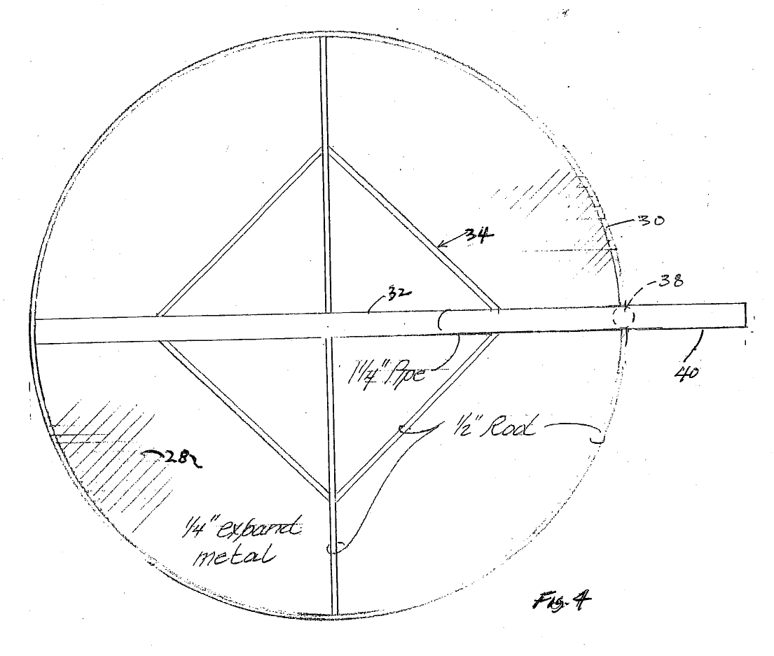

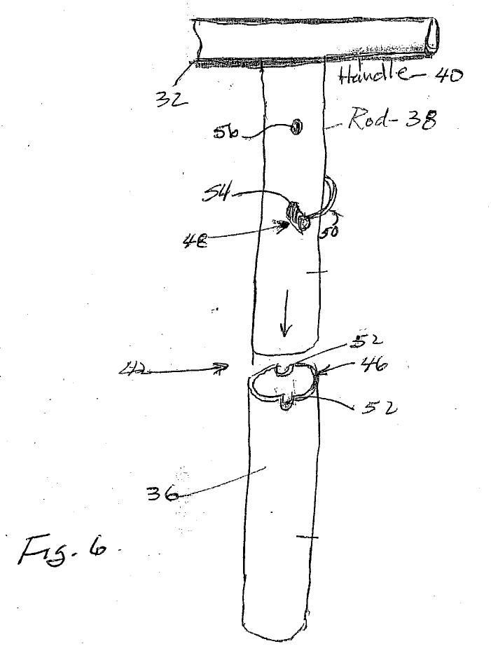

Also, as shown in FIG. 3, an upper edge of the cylinder 12 may include a series of circumferentially spaced slots 80 for supporting skewers or other food supporting utensils.

Accordingly, the present invention is to be limited in its scope only by the following claims.

1. A barbeque apparatus, comprising:
a heat source container having an open top;
a grill; and
a support structure supporting the grill to extend over the open top and for horizontal movement away from and toward the container to control the amount of heat from a heat source in the container reaching different portions of the grill.

2. The barbeque of claim 1 wherein the support structure supports the grill for vertical and horizontal movement relative to the container.

3. The barbeque of claim 1 further including releasable locking structure for securing the grill over the container.

4. The barbeque of claim 1 wherein the support structure includes a pivot structure for swinging the grill away from and towards the container.

5. The barbeque of claim 4 wherein the pivot structure includes support for the grill at different vertical positions.

6. The barbeque of claim 1 further comprising a heat shield surrounding a vertically extending portion of the container.

7. The barbeque of claim 1 wherein:
the container comprises a vertically extending metal cylinder including the open top,
the grill comprises a horizontally extending grid, and
the support structure comprises a pivot for horizontally pivoting the grill on a vertical axis.

8. The barbeque of claim 7 wherein the pivot comprises a vertically extending sleeve secured relative to the container and a vertically extending rod secured to the grill and extending into the sleeve to support the grill for horizontal swinging movement over the open top of the cylinder.

9. The barbeque of claim 8 further including a handle secured to the rod for turning the rod in the sleeve to swing the grill over the open top of the cylinder.

10. The barbeque of claim 8 wherein the pivot includes releasable locking means for securing the grill over the open top of the cylinder.

11. The barbeque of claim 10 wherein the releasable locking means includes a cam surface on the sleeve and a cam follower on the rod for riding on the cam surface.

12. The barbeque of claim 11 wherein the cam follower comprises a pin extending horizontally from the rod to ride on the cam surface on the sleeve.

13. The barbeque of claim 12 wherein the rod includes a plurality of vertically spaced horizontally extending holes for selectively receiving the pin to provide vertical adjustment of the grill from the open top of the cylinder.

14. The barbeque of claim 8 including a locking member carried by the sleeve for selectively engaging and locking against the rod to releasably secure the rod within the sleeve and the grill structure relative to the container.

15. The barbeque of claim 8 wherein the sleeve includes an internally threaded portion engaging an externally threaded portion of the rod whereby a turning of the rod relative to the sleeve moves the grill structure vertically relative to the heat source container, and further including a locking nut on the rod for engaging and locking the rod relative to the sleeve.

16. The barbeque of claim 8 wherein the heat source container includes side air vents adjacent a lower end of the cylinder.

17. The barbeque of claim 8 including support for charcoal or wood within the cylinder.

18. The barbeque of claim 8 wherein the cylinder includes an upper edge with spaced slots.
